(19) United States
(12) Patent Application Publication
(10) Pub. No.: US 2019/0168163 A1
(43) Pub. Date: Jun. 6, 2019

(54) ULTRA-FILTRATION MEMBRANE AND METHOD OF FORMING THE SAME

(71) Applicant: Stuart Miller, Clayton, NC (US)

(72) Inventor: Stuart Miller, Clayton, NC (US)

(21) Appl. No.: 15/828,505

(22) Filed: Dec. 1, 2017

(51) Int. Cl. B01D 63/02; B01D 69/08; B01D 71/02; B01D 61/14; B01D 61/18

(52) U.S. Cl. CPC B01D 63/02; B01D 69/08; B01D 71/02; B01D 2313/13; B01D 61/18; B01D 2313/146; B01D 61/145

(57) ABSTRACT

An ultra-filtration membrane assembly having an exterior housing having a housing; an ultra-filtration membrane provided within the housing, the ultra-filtration membrane being having a plurality of elongated filtration fibers arranged in a spiraled coil; and one or more filaments woven around the plurality of elongated filtration fibers thus binding each of the one or more adjacent elongated filtration fibers at a predetermined axial spacing from one another.

### TECHNICAL FIELD

The present disclosure generally relates to the field of ultra-filtration for the purpose of purifying water or other fluid streams.

### BACKGROUND

Filtration systems operate in a wide variety of applications, even when constrained to water filters. Such filters can be found anywhere from wastewater plants to nuclear power plants, and from commercial application, to hospitals. It is well understood that these systems operate in an optimal fashion when the filter elements are replaced or cleaned at very particular intervals. It will be appreciated that these systems have been separate and distinct systems which can be large and burdensome to maintain and/or replace.

### SUMMARY OF THE INVENTION

Contemplated herein is an ultra-filtration filter membrane assembly which can include a plurality of elongated filtration fibers being woven or bound together by one or more filaments or strings.

In some embodiments the one or more filaments can be woven around the plurality of elongated filtration fibers thus binding one or more adjacent elongated filtration fibers at a predetermined axial spacing. In some such embodiments the one or more filaments can be provided having a woven fiber filament structure. Additionally, the woven fiber filament structure can be provided having at least some para-aramid synthetic fiber, i.e. KEVLAR™. Further, the one or more filaments can be woven around the elongated filtration fibers at a plurality of predetermined axial positions along the respective lengths of the elongated filtration fibers so as to provide increased stability and maintain proper spacing at various points along the length of the ultrafiltration membrane.

In some embodiments the ultrafiltration membrane as a whole can be formed by providing a plurality of the elongated filtration fibers in a planar configuration wherein each fiber is arranged adjacent the next and then each adjacent fiber is bound to adjacent fibers using the filament. In this manner the width of the filament itself maintains proper spacing between adjacent elongated filtration fibers, particularly when woven around an entire circumference of each elongated filtration fiber.

In this manner, respective adjacent elongated filtration fibers can initially be provided in a co-planar configuration, while the filament allows for rotation and relative axial flexibility, wherein the plurality of filtration fibers can then be rolled into a cylindrical coil configuration for later insertion into a housing. In this embodiment, because of the weaving of the filament around the entire circumference of each elongated filtration fiber, not only are the adjacent planar fibers properly spaced, but also adjacent elongated filtration members from adjacent coil layers.

In some embodiments, the elongated filtration fibers can also be provided as tubular ceramic media.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such claims.

These aspects of the invention are not meant to be exclusive and other features, aspects, and advantages of the present invention will be readily apparent to those of ordinary skill in the art when read in conjunction with the following description, appended claims, and accompanying drawings. Further, it will be appreciated that any of the various features, structures, steps, or other aspects discussed herein are for purposes of illustration only, any of which can be applied in any combination with any such features as discussed in alternative embodiments, as appropriate.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention, wherein:

FIG. 1 illustrates a perspective end view of an ultrafiltration membrane assembly in accordance with various aspects of the present invention

FIG. 2 illustrates a perspective end view of an end portion of a plurality of ultrafiltration fibers for use within the ultrafiltration membrane assembly of FIG. 1;

FIG. 3 illustrates a perspective view of a plurality of ultrafiltration fibers in a weaving or binding step in a planar configuration for later insertion into the ultrafiltration membrane assembly of FIG. 1;

FIGS. 4A-B illustrate perspective views of a filament configuration and resulting ultrafiltration fiber spacing of the binding step illustrated in FIG. 3;

FIGS. 5A-B illustrate side views how the bound planar ultrafiltration fibers of FIG. 3 can be rolled into a spiraled coil and cut to a uniform length prior to use in the ultrafiltration membrane assembly of FIG. 1; and

FIG. 6 illustrates a cross-sectional end view of the ultrafiltration membrane of FIG. 1.

### DETAILED DESCRIPTION OF THE INVENTION

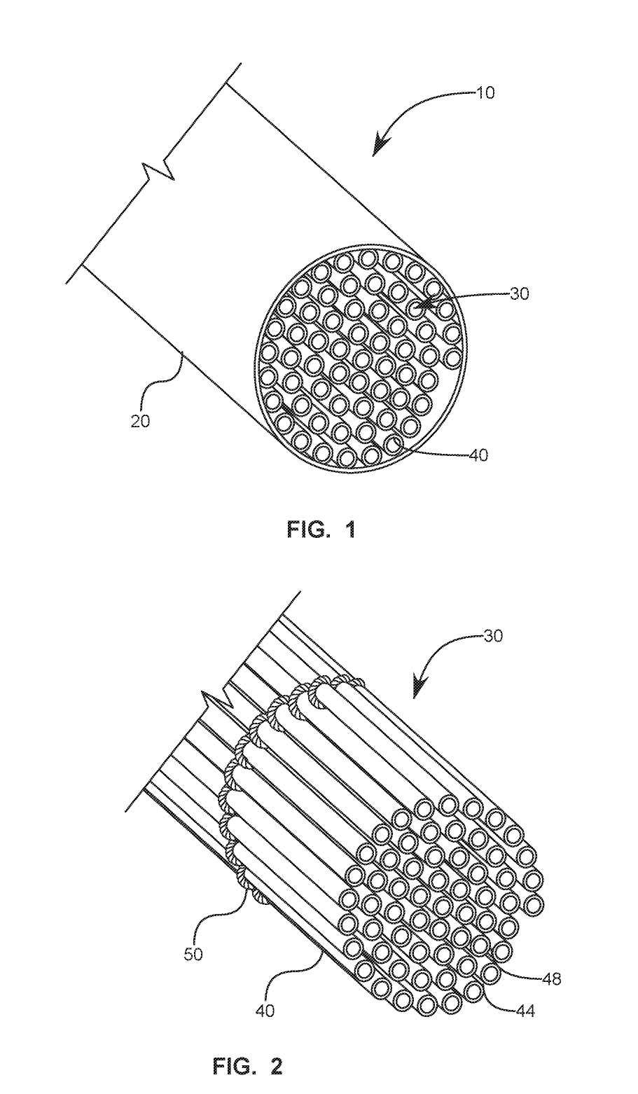

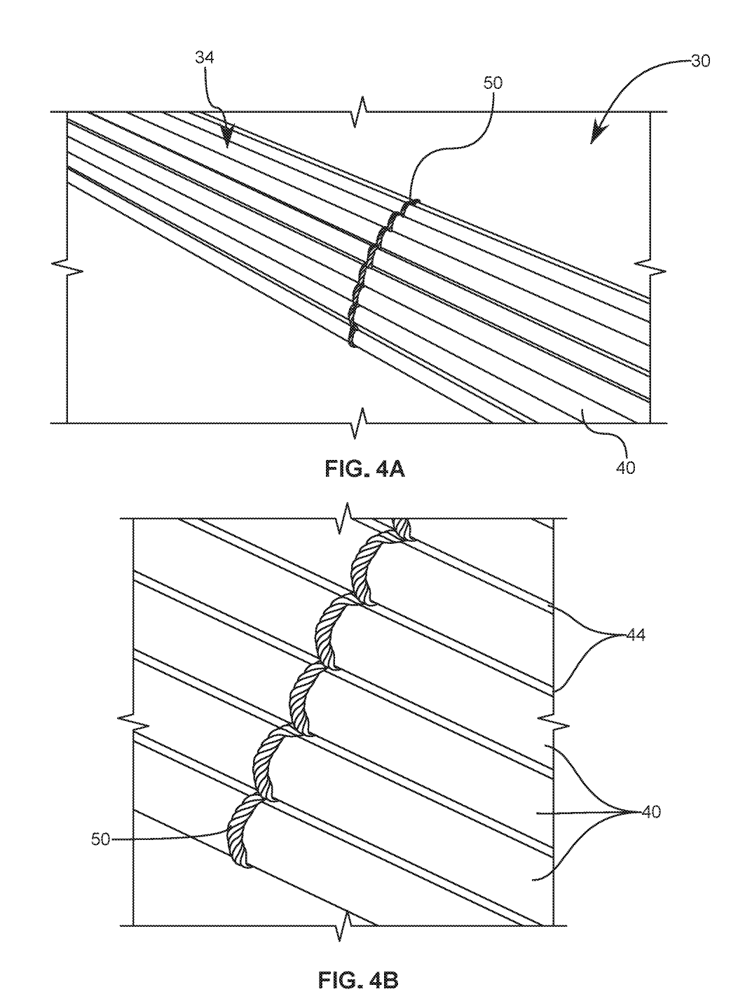

As discussed above, contemplated herein is an ultra-filtration membrane assembly 10 which can be utilized in a variety of applications yet is small and compact. In accordance with this and various other aspects of the present invention the ultra-filtration membrane assembly 10 is illustrated in FIGS. 1-6, which allows for a tightly packed assembly of ultrafiltration fibers having uniform and predetermined spacing between the various fibers within the assembly.

It will be understood that while the ultra-filtration membrane assembly 10 will be discussed primarily with regard to water purification, it can be similarly applied to alternative solutions or fluids as desired. By way of example, such filtration can be utilized for applications ranging from water purification to the industrial applications such as metal separation, pharmaceutical and biopharma production, as well as sugar manufacturing, and even juice or dairy processing.

It will also be understood that the ultra-filtration membrane assembly 10 can have varying configurations with regard to whether contaminated flows are introduced to an interior portion 42 of the ultrafiltration fibers 40, where purified flow is then received from an exterior side of the ultrafiltration fibers, or in contrast whether contaminated flows are introduced to an exterior portion of the ultrafiltration fibers, where purified flow is then received from an interior portion 42 of the ultrafiltration fibers 40. In some embodiments described, this can be achieved by merely switching or reversing the inlet and outlet.

As such FIG. 1 illustrates an ultra-filtration membrane assembly 10 being provided within a housing 20. The housing 20 is shown herein as a cylindrical tube but can be provided having virtually any shape. The housing 20 is configured to receive an ultra-filtration membrane assembly 30, the ultra-filtration membrane 30 being comprised of a plurality of elongated filtration fibers 40 arranged in a spiraled coil.

The ultra-filtration membrane 30 is shown in FIG. 2 as being removed from the housing 20. It will also be understood that the spiraled coil as illustrated herein is provided in a cylindrical or round shape, but could be coiled into any number of other geometric shapes so as to correspond in shape to an interior surface of the housing, in whatever shape the housing may take.

As illustrated in FIGS. 2-6, the ultra-filtration membrane 30 which includes the plurality of elongated filtration fibers 40 which are bound together using one or more filaments 50, wherein the filaments 50 can be woven around the plurality of elongated filtration fibers 40 thus binding each of the one or more adjacent elongated filtration fibers 40 at a predetermined axial spacing from one another.

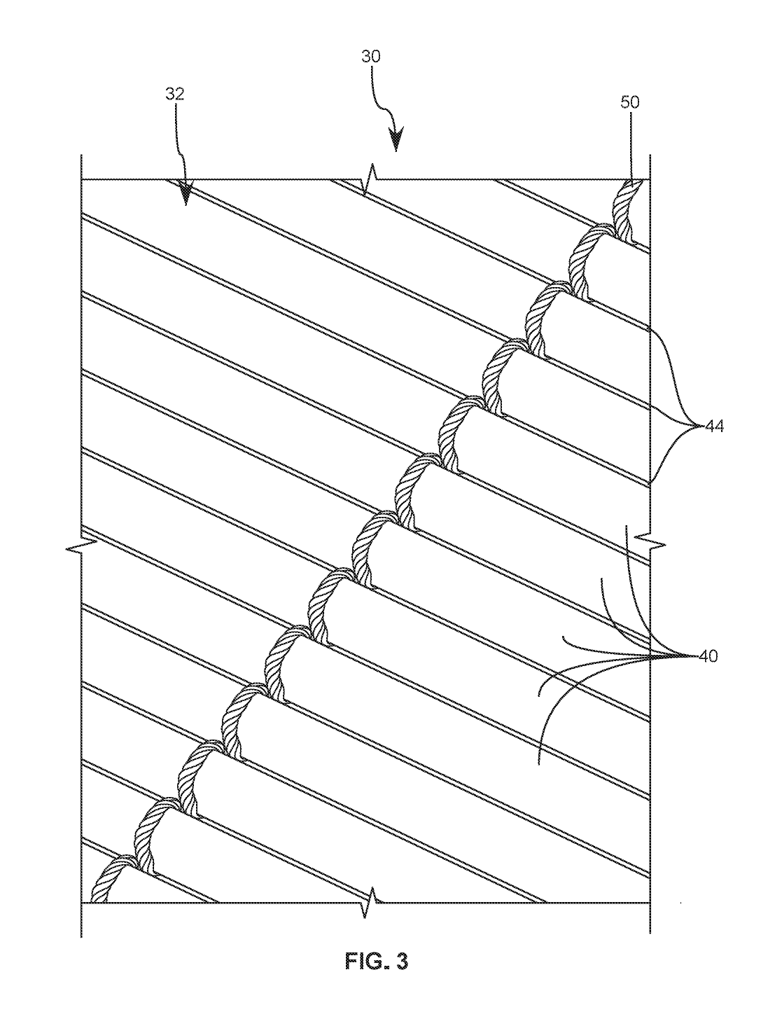

In particular FIG. 3 illustrates an assembly step in which the plurality of elongated filtration fibers 40 are arranged in a co-planar configuration or arrangement and wherein at least one filament 50 is woven between the plurality of elongated filtration fibers 40. As shown herein, the filament 50 is a single strand which is looped and then woven in an over-under configuration such that each of the plurality of elongated filtration fibers 40 have filament 50 extending around an entire circumference thereof. As such, the width of the filament 50 provides the pre-determined spacing between each of the plurality of elongated filtration fibers 40. It will then be understood that the spacing can be varied by providing a filament 50 having a specific pre-determined width, which can vary based on the particular filament used. This width can then be utilized to maintain a predetermined spacing between adjacent elongated filtration fibers 40, this spacing illustrated by the numeral 44, but the spacing will also be similar or consistent between adjacent elongated filtration fibers 40 between coil layers, as illustrated by the numeral 48.

This alternating over-under weaving pattern as shown herein can also be varied. For example, instead of merely alternative between extending over and under each of the plurality of elongated filtration fibers 40, the filament 50 can be twisted or knotted between each of the plurality of elongated filtration fibers 40. Alternatively, knots or other rigid spacers can be provided along the length of the filament at pre-determined intervals so as to provide additional stability or spacing parameters as desired.

In some embodiments the one or more filaments 50 can be provided having a woven fiber filament structure, and in some instances advantages of using a filament formed of or having para-aramid synthetic fibers, i.e. Kevlar™, have been realized.

It will also be understood that the filament 50 can be provided utilizing any number of synthetic or naturally occurring fibers so as to provide the desired spacing, wear, corrosion, or binding strength parameters, as recognized and as necessary for the fluid being filtered by the system.

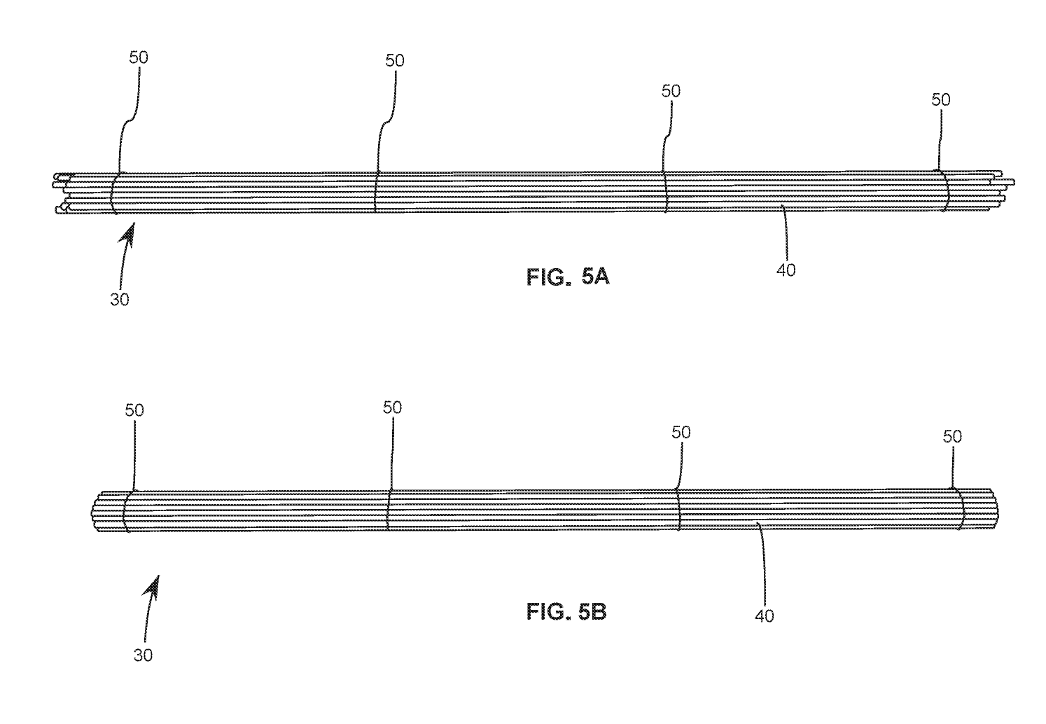

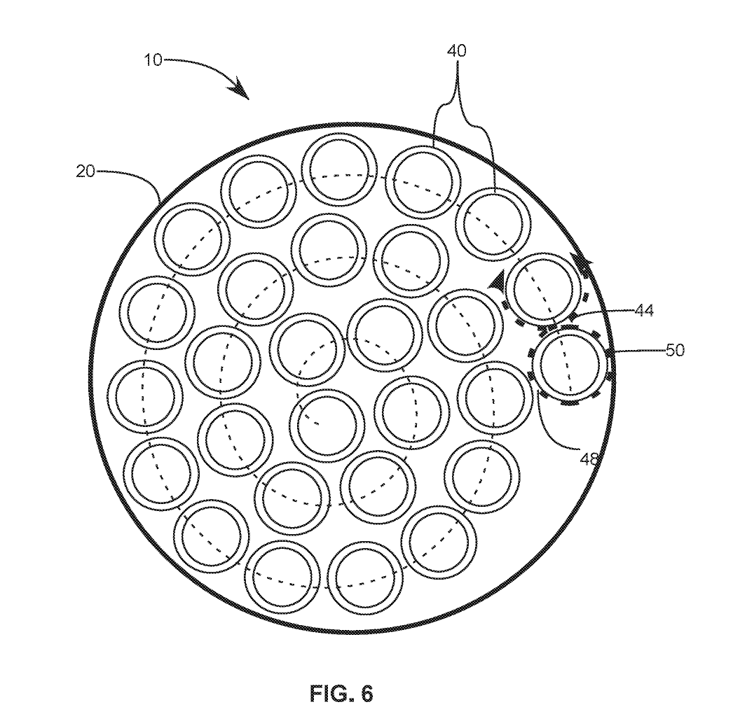

Certain advantages have also been realized by providing a plurality of filaments 50, as illustrated in FIGS. 5A-B, wherein the plurality of filaments 50 are woven around the elongated filtration fibers 40 at a plurality of predetermined axial positions along the respective lengths of the elongated filtration fibers 40. By providing a plurality of filaments 50, the binding and stability of the elongated filtration fibers 40 can be increased, and the spacing along the entire length between each of the elongated filtration fibers 40 ensured.

As illustrated in FIG. 2, the filament 50 can be woven in a manner such that it extends at an angle between adjacent elongated filtration fibers 40 instead of perpendicular to an axial direction, as defined by a central axis of each elongated filtration fiber 40. In this manner as the co-planar elongated filtration fibers 40 are rolled into a coil or spiral, the filament will then resemble a helical coil and thus prevent the filament 50 from interfering with itself between adjacent coil layers and thus prevent clogging of the filter or preventing flow between the plurality of elongated filtration fibers 40 in use.

As such, for purposes of assembly, each elongated filtration fiber 40 is bound to each respective adjacent elongated filtration fibers in a co-planar configuration, as illustrated in FIG. 3, and then, because the filament 50 is flexible and allows a certain degree of relative rotation, the plurality of filtration fibers can then be rolled into a cylindrical coil configuration as illustrated in FIGS. 2, and 4-6, for placement within the housing 20.

It will be appreciated that the elongated filtration fibers 40 as illustrated herein as a tubular filtration media, and in particular as a ceramic ultra-filtration media. It will then be understood that flow can be introduced into a central portion of the tubular elongated filtration fibers 40, wherein an ultra-filtered fluid can then be collected from an exterior 46 portion which has passed through the sidewalls thereof. Or, alternatively, flow can be introduced to an exterior sidewall 46 portion, and an ultra-filtered fluid can then be collected from an interior portion 42 which has passed through the sidewalls thereof.

Also recognized herein, is that providing elongated filtration fibers 40 each having exactly the same length, and rolling into a coil such that each of the ends line up perfectly can be difficult based on material or coiling process. As such, the elongated filtration fibers 40 can be cut after the coil is formed such that the ends each reside within a particular tolerance threshold one from another.

Another advantage of providing multiple woven sections of filament 50, as shown in FIGS. 5A-B is that in some instances the ceramic ultrafiltration fibers can be extremely brittle and fracture easily; especially as the length of the ceramic fibers increase. Thus, the woven fibers placed at predetermined distances can increase the overall strength of the bound filtration fibers 40.

The media for the ultra-filtration membrane can including resin, ceramic tubes with micro or nano-sized apertures or pathways, other materials with micro or nano-sized apertures or pathways, carbon materials including activated carbon, and so forth.

It will then be appreciated that the housing 20 can be filled with a layer of resin or other blocking material such that the flow through the interior portion 42 of each of the elongated filtration fibers 40 can be separated from the flow received from the exterior portion 46 of each of the elongated filtration fibers 40, such as through a sidewall of the housing 20. Alternatively, the interior ends of each of the elongated filtration fibers 40 can be filled with a layer of resin or other blocking material such that the flow through the interior portion 42 of each of the elongated filtration fibers 40 can be separated from the flow received from the exterior portion 46 of each of the elongated filtration fibers 40.

These aspects of the invention are not meant to be exclusive and other features, aspects, and advantages of the present invention will be readily apparent to those of ordinary skill in the art when read in conjunction with the following description, appended claims, and accompanying drawings. Further, it will be appreciated that any of the various features, media, steps, or other aspects discussed herein are for purposes of illustration only, any of which can be applied in any combination with any such features as discussed in alternative embodiments, as appropriate.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention. Additionally, any features, structures, components, method steps which are discussed in reference to any one of the aforementioned embodiments are readily adaptable for use into and with any features of the other alternative embodiments discussed therein, with the understanding that one of ordinary skill in the art will be capable of assessing the ability of the various embodiments disclosed and be capable of making such adaptations.

What is claimed:

1. An ultra-filtration membrane assembly, the assembly comprising:
a housing;
an ultra-filtration membrane provided within the housing, the ultra-filtration membrane being comprised of a plurality of elongated filtration fibers arranged in a spiraled coil; and
one or more filaments woven around the plurality of elongated filtration fibers thus binding each of the one or more adjacent elongated filtration fibers at a predetermined axial spacing from one another.

2. The ultra-filtration membrane assembly of claim 1, wherein the one or more filaments are provided having a woven fiber filament structure.

3. The ultra-filtration membrane assembly of claim 2, wherein the woven fiber filament structure is provided having a para-aramid synthetic fiber.

4. The ultra-filtration membrane assembly of claim 1, wherein a plurality of filaments are woven around the elongated filtration fibers at a plurality of predetermined axial positions along the respective lengths of the elongated filtration fibers.

5. The ultra-filtration membrane assembly of claim 1, wherein each elongated filtration fiber is bound to respective adjacent elongated filtration fibers in a co-planar configuration, and wherein the plurality of filtration fibers are then rolled into a cylindrical coil configuration for placement within the housing.

6. The ultra-filtration membrane assembly of claim 1, wherein the elongated filtration fibers are provided as tubular ceramic media.

7. The ultra-filtration membrane assembly of claim 1, wherein at least one of the plurality of filaments is twisted or knotted between each of the plurality of elongated filtration fibers.

8. A method of providing and using an ultra-filtration membrane assembly, the method comprising:
providing a housing, the housing being annular in shape;
providing an ultra-filtration membrane within the housing, the ultra-filtration membrane being comprised of a plurality of elongated filtration fibers arranged in a spiraled coil; and
binding the plurality of elongated filtration so as to have a pre-determined spacing by utilizing one or more filaments woven around the plurality of elongated filtration fibers.

9. The method of providing and using an ultra-filtration membrane assembly of claim 8, wherein the one or more filaments are provided having a woven fiber filament structure.

10. The method of providing and using an ultra-filtration membrane assembly of claim 9, wherein the woven fiber filament structure is provided having a para-aramid synthetic fiber.

11. The method of providing and using an ultra-filtration membrane assembly of claim 8, wherein a plurality of filaments are woven around the elongated filtration fibers at a plurality of predetermined axial positions along the respective lengths of the elongated filtration fibers.

12. The method of providing and using ultra-filtration membrane assembly of claim 8, wherein each elongated filtration fiber is bound to respective adjacent elongated filtration fibers in a co-planar configuration, and wherein the plurality of filtration fibers are then rolled into a cylindrical coil configuration for placement within the housing.

13. The method of providing and using ultra-filtration membrane assembly of claim 8, wherein the elongated filtration fibers are provided as tubular ceramic media.

14. The method of providing and using ultra-filtration membrane assembly of claim 8, wherein the binding the plurality of elongated filtration so as to have a pre-determined spacing by utilizing one or more filaments woven around the plurality of elongated filtration fibers comprises twisting or knotting

15. An ultra-filtration membrane assembly, the assembly comprising:
a housing;
an ultra-filtration membrane provided within the housing, the ultra-filtration membrane being comprised of a plurality of elongated filtration fibers wherein the elongated filtration fibers are provided as tubular ceramic media;
one or more filaments woven around the plurality of elongated filtration fibers thus binding one or more adjacent elongated filtration fibers at a predetermined axial spacing; and
wherein a plurality of filaments are woven around the elongated filtration fibers at a plurality of predetermined axial positions along the respective lengths of the elongated filtration fibers; and
wherein the plurality of filtration fibers are provided in a cylindrical coil configuration within the housing.

16. The ultra-filtration membrane assembly of claim 155, wherein the one or more filaments are provided having a woven fiber filament structure, and wherein the woven fiber filament structure is provided having a para-aramid synthetic fiber.

17. The ultra-filtration membrane assembly of claim 15, wherein each filament of the plurality filaments is twisted or knotted between a respective one of each of the plurality of elongated filtration fibers.
